(19) United States
(12) Patent Application Publication
(10) Pub. No.: US 2017/0155103 A1
(43) Pub. Date: Jun. 1, 2017

(54) DEVICE AND METHOD FOR TRANSPORTING GALVANIC CELLS

(71) Applicant: Genius Patentverwertung GmbH & Co. KG, Koenings Wusterhausen (DE)

(72) Inventor: Klaus-Michael Pasewald, Blankenfelde (DE)

(21) Appl. No.: 15/327,184

(22) PCT Filed: Jul. 16, 2015
(86) PCT No.: PCT/EP2015/066258

§ 371 Date: Jan. 18, 2017

(30) Foreign Application Priority Data
Jul. 29, 2014 (DE) 10 2014 110 654.7

(51) Int. Cl. H01M 2/10; C03C 11/00; A62C 3/16; A62C 3/06; H01M 10/54; H01M 10/0525

(52) U.S. Cl. CPC H01M 2/1005; H01M 10/54; H01M 10/0525; A62C 3/16; A62C 3/06; C03C 11/002

(57) ABSTRACT

An apparatus and method for transporting used, damaged, or defective galvanic cells while impeding and combating safety-critical states of the galvanic cells, in particular lithium-ion-based cells and/or lithium-ion polymer cells, includes an outer container, which defines a space, an inner container being arranged in the space. The inner container has spacers in order to maintain a distance from the bottom and inner faces of the outer container, an accommodating container for accommodating at least on galvanic cell being arranged in the inner container, free intermediate spaces being filled with a fire protection agent composed of inert, non-conductive, non-flammable, absorbent hollow glass granular material.

### CROSS REFERENCE TO RELATED APPLICATIONS

The present application claims the priority benefits of International Patent Application No. PCT/EP2015/066258, filed on Jul. 16, 2015, which claims priority of DE 10 2014 110 654.7, filed on Jul. 29, 2014, which are hereby incorporated herein by reference in their entirety.

### BACKGROUND OF THE INVENTION

The invention relates to an apparatus for transporting used, damaged or defective galvanic cells whilst preventing and controlling safety critical conditions of the galvanic cells with an outer container which defines a space, wherein an inner container is arranged in the space. While illustrated for use with particularly lithium ion-based cells and/or lithium ion polymer cells, it may be used with other types of galvanic cells. The invention also relates to a storage and transport method for used, damaged or defective galvanic cells and flame retardant pads for use with the apparatus.

In the present case, galvanic cells are understood to be apparatuses for spontaneously converting chemical energy into electrical energy which are divided into three groups:
a) primary cells, colloquially also referred to as a battery. It is characteristic that the cell is charged and can be discharged only once. The discharge is irreversible and the primary cell can no longer be electrically charged.
b) secondary cells, colloquially also referred to as a rechargeable battery. After a discharge, secondary cells can then be recharged by a current direction opposite to the discharge. In particular, lithium ion-based cells come into consideration within the scope of the invention.
c) Fuel cells, also referred to as tertiary cells. In the case of these galvanic cells, the chemical energy carrier is provided in a continuous manner externally. This permits a continuous operation which in principle is unrestricted in terms of time.

In principle, the invention can be applied to all three types of galvanic cells, but is especially useful with the metal ion-based cells and more particularly to the lithium-ion based cells and/or lithium ion polymer cells. For simplicity, only the term “battery” will be used hereinafter, even when referring to all types of galvanic cells.

Presently, lithium ion-based cells are used to an increasing extent in a variety of areas because their capacity in comparison to weight is advantageous. In particular, it is expected that their use in electric vehicles and hybrid vehicles, such as passenger cars or two-wheeled vehicles operated by rechargeable battery, will increase considerably in the future.

When batteries, in particular lithium ion batteries, fail, chemical substances (electrolyte) and particles can leak out of the interior of the battery. This released material is then present in solid, liquid or gaseous form and in combinations, e.g. as particles, dust, film, aerosol, liquid, droplet mist. Moreover, a significant amount of heat can occur as a result of chemical and/or electrical reactions. This material is in part highly reactive and harmful to health, and is possibly highly toxic. It is also possible that the released material will ignite causing fires and/or explosions. For instance, in almost all lithium ion batteries, for example, lithium hexafluorophosphate is used as the electrolyte which, in the event of a battery being damaged, can leak out and break down into highly reactive and toxic compounds (hydrofluoric acid etc.).

If, in spite of all safety measures, a safety critical condition arises, counter-measures have to be introduced. If e.g. a fire occurs, then fire-fighting measures and measures for avoiding contamination of the environment are required. In the present case, safety critical conditions include:
leakage of the electrolyte with possibly time-delayed formation of aggressive and poisonous compounds (e.g. hydrofluoric acid in lithium cells);
heating of the cell beyond the boiling point of the electrolyte;
gas formation;
opening of a safety valve and/or rupture of the housing;
leakage of the gas;
formation of an ignitable gas mixture with the influx of oxygen;
explosion of the gas mixture after ignition on an ignition source internal or external to the cell;
combustion of the components of the galvanic cell with the formation of smoke gases;
spreading of the fire to surrounding materials and devices.
   These safety critical conditions in the case of galvanic cells, in particular metal ion-based cells and more particularly preferred lithium ion-based cells, should be prevented or at least extensively inhibited.

DE 10 2006 019 739 B4 discloses a system for extinguishing fires in a hazardous object using an extinguishing agent having at least one storage container for the extinguishing agent, having a pipework system for transporting the extinguishing agent from the storage container to the fire, and having a conveying means for conveying the extinguishing agent from the storage container through the pipework system to the fire. The extinguishing agent used is a hollow round granulate which is resistant to a temperature up to at least 1000 degrees and whose diameter is between 0.1 mm and 5 mm This system has already proven successful but requires active conveying means, sensors etc. and is thus more likely to be considered for industrial installations.

EP 2 167 439 B1 discloses a use of a flame retardant consisting of a hollow round granulate of hollow glass spheres which is resistant to a temperature up to at least 1000° C., wherein the diameter of the round granulate is between 0.1 mm and 5 mm, for preventive fire protection by sustained application onto the hazardous object and/or sustained filling of the hazardous object with the flame retardant. This idea has also proven successful, but is suitable in particular for the floating application in fuel depots or filling of cable ducts etc.

WO 2011/015411 A1 discloses a method of fighting and/or preventing a fire in one or a plurality of battery cells, preferably lithium ion cells, in which an aqueous solution of a calcium salt and a gel extinguishing agent are used.

WO 2010/149611 A1 discloses a method of safely crushing batteries, comprising the steps of: a) providing one or a plurality of batteries to be crushed; and b) mechanically crushing the batteries provided, wherein the crushing process takes place in the presence of: i) at least one metal flame retardant which is suitable for suppressing or reducing a fire in the batteries; and ii) at least one binding agent which is suitable for binding acids and/or bases.

DE 10 2010 035 959 A1 discloses a transport apparatus for hazardous goods, in particular electrochemical energy storage devices, which can have a safety device and a container for the hazardous goods which is filled with a filling material.

### SUMMARY OF THE INVENTION

The invention provides an alternative for transporting and storing used, damaged or defective galvanic cells whilst preventing and controlling safety critical conditions of the galvanic cells, which facilities handling, permits safe transport or storage and allows the most error-free handling possible.

An apparatus and method for transporting used, damaged or defective galvanic cells, according to an aspect of the invention, includes an outer container which defines a space, wherein an inner container is arranged in the space wherein the inner container has spacers in order to maintain a distance from the base and inner sides of the outer container, wherein at least one receiving container that is adapted to receive at least one galvanic cell is arranged in the inner container, wherein free intermediate spaces between inner container and outer container as well as receiving container are filled with a flame retardant as a loose filling consisting of inert, non-conductive and non-combustible and absorbent hollow glass granulate and free intermediate spaces between the inner container and receiving container are filled with flame retardant pads consisting of inert, non-conductive and the non-combustible and absorbent hollow glass granulate and that the outer container is a container for the transport of hazardous goods.

In accordance with aspects of the invention, it has been recognised that, if the inner container has spacers in order to maintain a distance from the base and inner sides of the outer container, wherein at least one receiving container for receiving at least one galvanic cell is arranged in the inner container, wherein free intermediate spaces are filled with a flame retardant consisting merely of inert, non-conductive and non-combustible and absorbent hollow glass granulate, it becomes possible to permit particularly safe transport because slipping is practically excluded by virtue of the nested arrangement. This is a “box in box” design.

Moreover, it now becomes possible to fill the outer container gradually. In other words, the receiving containers are filled with the damaged batteries. When they are full, they are placed inside the inner container and surrounded by the flame retardant (cf. below). Then—depending upon the size of the receiving containers and the batteries to be disposed of—a further receiving container can be filled gradually and then, in turn, can be introduced into the inner container and surrounded by flame retardant. For instance, the smaller, portable receiving container can be positioned temporarily at the required location and can be introduced into the outer container for actual storage or transport. This renders it possible for the first time to introduce a take-back system for lithium-ion batteries, as is hitherto known for the unproblematic, conventional alkali batteries.

The inner container may be divided into at least two compartments, wherein then the compartments are separated preferably by means of a vertically extending wall. This increases the stability of the inner container and, on the other hand, it even more effectively prevents slippage or the spread of a critical condition.

In one embodiment, the base of the inner container is provided with openings or a lattice base so that, on the one hand, the inner container can be introduced into, or removed from, an outer container containing frame retardant as a loose filling without any problem. Electrolyte leaking from the batteries can thus also run off (onto/into flame retardant below the inner container) so that the inner container can remain free.

In order to simplify placement of the receiving containers and to ensure that they are arranged correctly in the inner container, the inner container can have a vertically extending rail on the inner sides of the side walls for receiving and guiding the receiving containers.

A basket which is permeable to the flame retardant at least at the base and is intended for receiving at least one galvanic cell can be arranged in the receiving container so that the process of introducing the batteries into, and in particular lifting them out of, the flame retardant is simplified, if the receiving container is likewise filled.

In this manner it becomes possible to load the batteries in question into the basket from outside of the container and to lower the basket as a whole in the container filled with flame retardant. In a similar manner, it is simple to empty the receiving container, for which purpose only the basket has to be lifted out. In both cases, by reason of the permeability the flame retardant penetrates into (or flows out of) the basket and surrounds the batteries, so that they are embedded (or exposed). Preferably, the basket is a wire basket which consists optionally of powder coated wire. Alternatively, the basket can also have only one permeable (wire mesh) base and can have solid impermeable side walls.

The basket may consist of a non-conductive material. In order to ensure that the distances from the container walls are maintained, the basket can be provided with spacers. Therefore, the basket is introduced into the container filled with flame retardant. The distances are thus “automatically” maintained, even during transport in spite of shaking and jerking movements. Furthermore, the basket can be provided with partitions in the interior, in order to form compartments for individual batteries, so that they always maintain the required distance from one another. In the simplest case, the spacers can be constituted by a bracket construction which is formed e.g. as part of the basket and protrudes outwardly. The spacers can be arranged on the base and/or on the side walls of the basket, so that the distances from the base and/or the side walls are maintained and these are filled with flame retardant. The mesh width or size of the openings can be adapted to the size of the flame retardant.

The basket can be provided with holders in order to simplify manual or mechanical handling, e.g. withdrawal. They can be e.g. bracket handles, eyelets etc.

The flame retardant may consist of hollow glass granulate, i.e. it contains only hollow glass granulate and otherwise no further components. Preferably, the hollow glass granulate is a hollow round granulate or a round granulate provided with hollow regions, which is resistant to a temperature up to at least 750°, preferably 1000° C., and preferably has a mean diameter between 0.1 mm and 10 mm A mean diameter between 0.1 mm and 5 mm is more preferred. Such hollow glass granulate is also known as foam glass granulate.

The hollow glass granulate used in an embodiment has a grain size, which is calculated according to the safety risk, and a cavity portion for avoiding ignition by cooling and for extinguishing a fire by suffocation and/or oxygen exclusion and for preventing the formation of an inflammable gas mixture, and a grain size, which is calculated according to the safety risk, for preventing an explosion, i.e. an explosive atmosphere, displacing oxygen and preventing ignition sources. Furthermore, it does not have any electrical conductivity whatsoever. Moreover, it is absorbent and thus can absorb electrolytes which have leaked out of the cells.

The flame retardant can be used (in all regions of the apparatus) as a loose filling and/or in the form of correspondingly filled flame retardant pads, i.e., the pads have only the flame retardant as the filling. The cover thereof consists of a temperature-resistant (non-combustible or flame-resistant), dust-impermeable, moisture-permeable flexible fabric, such as e.g. glass fibre fabric. Alternatively, polyethylene fabrics or film can also be used. Then, the pad disintegrates “actively” during the fire and the filling is released. It has been demonstrated that the particular flame retardant of the hollow glass granulates is suitable for storing and transporting used, damaged or defective batteries or galvanic cells, in particular lithium ion-based cells.

The properties of the hollow glass granulates used are stated above and are also used in the embedding procedure. The flame retardant acts by “suffocating” the potential fire because the round granulate is deposited onto the galvanic cells in such a manner as to displace and seal off air according to the close-packing of spheres from a certain layer thickness.

The round granulate consists of an inert glass material. This permits a particularly effective filling, flowing and creeping capability and thus reliable transport properties and coverage of the area of the fire, even in narrow and otherwise poorly accessible areas, such as gaps. Therefore, this also prevents the potential fire from being supplied with oxygen.

In addition, the hollow glass granulate may also be absorbent, i.e., it can absorb and bind leaking electrolytes.

If the flame retardant is used in the form of the flame retardant pads or the filling thereof, it is considerably easier and simpler to handle. The flame retardant pads can “simply” be placed underneath, between, around, adjacent to and/or onto the regions in question, wherein the pads can be deformed into the required shape. Moreover, the release of dust is extensively prevented so that no respiratory protection is required. Dry ice or vermiculite can be used as the further filling.

The system permits the reuse of the flame retardant without any problems and it is practically wear-free. The flame retardant only has to be replaced when it has been used up or has become contaminated.

In accordance with an embodiment, the galvanic cells in question are embedded in a hollow glass granulate serving as a flame retardant for storage/transport for preventing safety critical conditions in the apparatus described above.

No active monitoring is required for triggering the discharge and/or application of an extinguishing agent. In the event that the cells are ignited, the closed container prevents the spread of fire and contamination. The hollow glass granulate suffocates a fire which has occurred within a short period of time or does not even allow said fire to develop, and absorbs leaked electrolyte. The cells are embedded directly in a quantity of the hollow glass granulate calculated according to the safety risk.

The outer container may have at least one safety valve for preventing overpressure. In addition, on the inner side of the outer container the safety valve can be protected against the ingress of hollow glass granulate by means of a lattice network, foam etc.

### BRIEF DESCRIPTION OF THE DRAWINGS

Further features and details of the invention will be apparent from the following description of the drawing, in which:

FIG. 1 shows a schematic lateral sectional view of a container in accordance with the invention for collecting, storing and transporting lithium ion batteries, and

FIG. 2 is a sectional view taken along line A-A of FIG. 1.

### DESCRIPTION OF THE PREFERRED EMBODIMENT

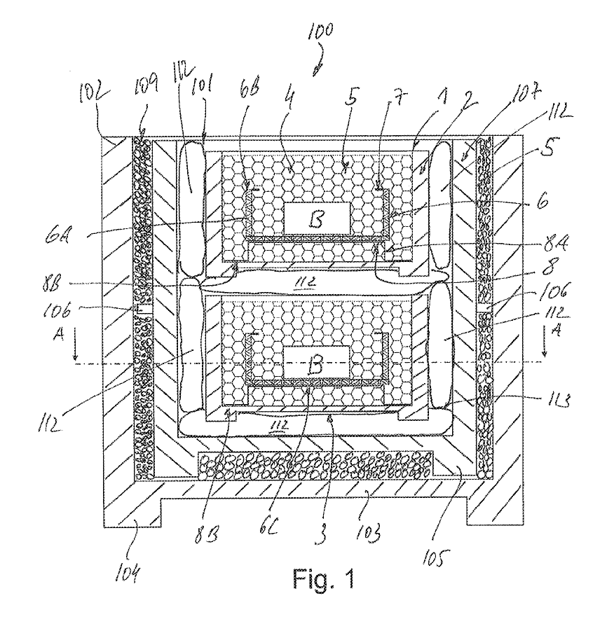

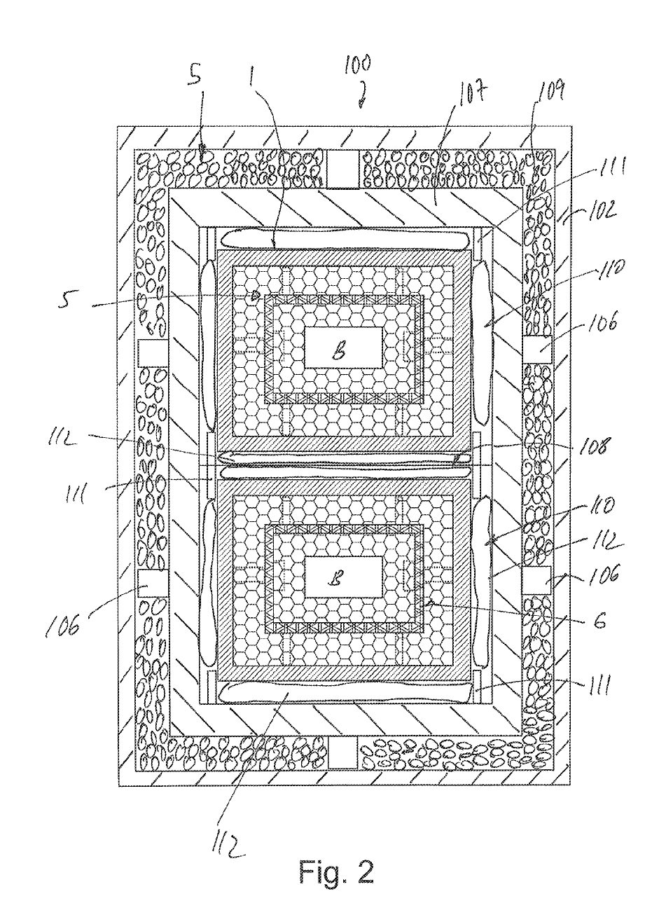

FIGS. 1 and 2 illustrate a closable outer container consisting of fireproof material and designated in its entirety by the reference sign 100. For improved clarity, the lid provided has been left out of FIGS. 1 and 2. On the inside, the outer container 100 has initially an inner container 101 in which, in turn, four receiving containers 1 are placed, two next to each other and two on top of each other.

The outer container 100 is a safety container for the transport of hazardous goods and has a pressure relief valve (not shown). The outer container 100 has an outer wall 102 and a base 103 (as well as the lid, not illustrated) and has feet 104 on the bottom four corners.

Arranged spaced apart from the inner sides of the outer wall 102 and the base 103 is the inner container 101 which for this purpose is provided with lateral, outwardly protruding spacers 106 and feet 105. Its walls 107 are designed as double walls. Again, the inner space thus created is divided into two by means of a further vertical wall 108 so that two compartments 110 are produced in which in each case two receiving containers 1 are arranged one above the other.

The intermediate space 109 between the outer container 100 and the inner container 101 is filled with hollow glass granulate 5, as are the receiving containers 1 also. The receiving containers 1 are positioned in the compartments 110 by means of rails 111 so that they cannot slip. The rails 111 extend vertically on the inner sides of the walls 107 and 108 at a suitable distance. The inner container 101 or its compartments 110 are stuffed with flame retardant pads 112 which are arranged underneath the first receiving container 1 and between the receiving containers 1 and to the sides thereof.

The flame retardant pads 112 are filled with hollow glass granulate 5 and have a cover 113 in the form of a temperature-resistant, dust-impermeable, moisture-permeable flexible fabric consisting of synthetic material. The receiving container 1 defines by means of an outer wall 2 and a base 3 (and the lid which is not illustrated) in the interior a space 4 which is filled with a filling of hollow glass granulate 5. The hollow glass granulate 5 is inert, non-conductive and non-combustible and absorbent and only melts at a temperature above at least 1000° C. It has a mean diameter between 0.1 and 5 mm or 10 mm (as per screen analysis).

Inserted into the space 4 is a basket 6 consisting of powder coated wire mesh, of which the mesh width is configured such that the hollow glass granulate 5 can penetrate or flow unhindered through the mesh. Alternatively, a basket can be used, of which the side walls consist of impermeable walls, i.e. they are not perforated, and of which only the base is permeable.

In the present case, a defective battery B is placed in the basket 6. It is understood that a plurality of batteries could also be placed therein. Since the hollow glass granulate 5 can flow freely through the mesh of the basket, the battery B is surrounded on all sides by hollow glass granulate 5 or is embedded therein and the risk of uncontrolled occurrence of a critical condition is minimised or prevented. In order to ensure that the basket 6 can be introduced into and removed from the container 1, it has in each case two bracket handles 7 which protrude inwardly from the upper edge 6B of the basket 6. Furthermore, the basket is provided on the underside with two spacers 8 which each consist of a wire bracket and are spaced apart in the longitudinal direction of the basket.

The brackets 8 extend initially with a limb 8A from the basket base 6C downwards to the base 3 of the container and thus determine the distance of the basket 6 or the battery B arranged therein from the base. Then, the brackets 8 extend laterally outwards to the side wall 6A of the container 1, for which reason a further limb 8B bends. Therefore, the basket 6 is also positioned laterally in the container 1 and cannot slip, and so the distance from the side wall 6A is likewise fixed. The distance of the basket 6 in the remaining container dimension (viewing direction of FIG. 1) is similarly fixed either by the basket 6 itself or further brackets 9 (see FIG. 2, illustrated by broken lines).

The battery B can thus be placed into the basket 6 and the basket can then be introduced into the container 1, wherein already partially introduced hollow glass granulate 5 flows through the mesh at least of the base of the basket and thus surrounds the battery B. Subsequently, further hollow glass granulate 5 can be added (as a loose filling), in order to fill the space 4 in the container 1 completely or up to the desired fill level and cover the battery B. It is understood that fire retardant pads can also be used in a similar manner

However, if a critical safety event should occur, then gases, electrolyte etc. can leak out but are “captured” by the flame retardant pads 112 which also prevent the spread of fire, explosion etc.

As a precaution, the intermediate space between the inner container 101 and the outer container 100 is also filled with hollow glass granulate 5 so that, in this case, a further effective barrier is provided for preventing an environmental hazard. Therefore, manifold redundant safety is achieved by the inventive apparatus for transporting used, damaged or defective batteries B.

### LIST OF REFERENCE SIGNS

1 hazardous goods container
2 wall
3 base
4 space
5 hollow glass granulate
6 basket
6A side wall of the basket
6B edge of the basket
6C basket base
7 bracket handle
8 bracket
8A limb
8B limb
9 bracket
100 outer container
101 inner container
102 wall
103 base
104 foot
105 foot
106 spacer
107 wall
108 wall
109 intermediate space
110 compartment
111 rail
112 fire retardant pad
113 cover
B lithium ion polymer battery module

1. Apparatus for transporting used, damaged or defective galvanic cells, comprising:
an outer container which defines a space, wherein an inner container is arranged in the space wherein the inner container has spacers in order to maintain a distance from the base and inner sides of the outer container;
at least one receiving container that is adapted to receive at least one galvanic cell is arranged in the inner container, wherein free intermediate spaces between inner container and outer container as well as receiving container are filled with a flame retardant as a loose filling consisting of inert, non-conductive and non-combustible and absorbent hollow glass granulate and free intermediate spaces between the inner container and the receiving container are filled with flame retardant pads, consisting of inert, non-conductive and non-combustible and absorbent hollow glass granulate and that the outer container is a container for the transport of hazardous goods.

2. (canceled)

3. Apparatus as claimed in claim 1 wherein the inner container is divided into at least two compartments.

4. Apparatus as claimed in claim 2 wherein the compartments are separated by means of a vertically extending wall.

5. Apparatus as claimed in claim 1 wherein the base of the inner container is provided with openings or is a lattice base.

6. Apparatus as claimed in claim 1 wherein the inner container has a vertically extending rail on the inner sides of the side walls for receiving and guiding the receiving containers.

7. Apparatus as claimed in claim 1 wherein the hollow glass granulate is a hollow round granulate or a round granulate provided with hollow regions, which is resistant to a temperature up to at least 750° C.

8. Apparatus as claimed in claim 1 wherein the outer container comprising at least one pressure relief valve.

9. Storage and transport method for used, damaged or defective galvanic cells, said method comprising:
embedding the galvanic cells in a hollow glass granulate serving as a flame retardant for storage/transport for preventing safety critical conditions in an apparatus comprising an outer container which defines a space, wherein an inner container is arranged in the space wherein the inner container has spacers in order to maintain a distance from the base and inner sides of the outer container, wherein at least one receiving container that is adapted to receive at least one galvanic cell is arranged in the inner container, wherein free intermediate spaces between inner container and outer container as well as receiving container are filled with a flame retardant as a loose filling consisting of inert, non-conductive and non-combustible and absorbent hollow glass granulate and free intermediate spaces between the inner container and the receiving container are filled with flame retardant pads consisting of inert, non-conductive and non-combustible and absorbent hollow glass granulate and that the outer container is a container for the transport of hazardous goods.

10. Flame retardant pad comprising a cover and a filling, wherein the filling consists of a flame retardant consisting of inert, non-conductive and non-combustible and absorbent hollow glass granulate which is resistant to a temperature up to at least 750°, a hollow round granulate or a round granulate provided with hollow regions, and the cover consists of a temperature-resistant, dust-impermeable, moisture-permeable and flexible fabric.

11. Apparatus as claimed in claim 7 wherein the hollow glass granulate has a mean diameter between 0.1 mm and 10 mm.

12. Apparatus as claimed in claim 11 wherein the hollow glass granulate has a mean diameter between 0.1 mm and 5 mm.

13. Apparatus as claimed in claim 10 wherein the round grandulate has a mean diameter between 0.1 mm and 10 mm.

14. Apparatus as claimed in claim 13 wherein the round grandulate has a mean diameter between 0.1 mm and 5 mm.

15. Method as claimed in claim 9 used with lithium ion-based cells.

16. Apparatus as claimed in claim 3 wherein the base of the inner container is provided with openings or is a lattice base.

17. Apparatus as claimed in claim 3 wherein the inner container has a vertically extending rail on the inner sides of the side walls for receiving and guiding the receiving containers.

18. Apparatus as claimed in claim 3 wherein the hollow glass granulate is a hollow round granulate or a round granulate provided with hollow regions, which is resistant to a temperature up to at least 750° C.

19. Apparatus as claimed in claim 3 wherein the outer container comprising at least one pressure relief valve.
